(19) United States
(12) Patent Application Publication
(10) Pub. No.: US 2013/0294078 A1
(43) Pub. Date: Nov. 7, 2013

(54) MODULAR LED ILLUMINATING DEVICE

(71) Applicant: Chia-Tsung TSAO, Taipei (TW)

(72) Inventor: Chia-Tsung TSAO, Taipei (TW)

(21) Appl. No.: 13/463,573

(22) Filed: May 3, 2012

(51) Int. Cl. F21V 15/01; F21V 21/088; F21V 31/00

(52) U.S. Cl. 362/249.02

(57) ABSTRACT

The invention relates to a modular LED illuminating device that includes a case, multiple LED units and a power wire. The case has a front cover and a rear cover. Multiple holding holes are formed through the front cover, and a wire groove is formed on the rear cover. The multiple LED units are held by the multiple holding holes. The power wire is partially mounted in the wire groove and electrically connected to the multiple LED units. Compared with conventional fluorescent lamps, the modular LED illuminating device has long lifetime and saves more energy.

### BACKGROUND OF THE INVENTION

1. Field of the Invention

This invention relates to an LED illuminating device, especially to a modular LED illuminating device with multiple LED units.

2. Description of Related Art

A conventional advertising light box has a frame. At least one side of the frame has a diffuser. Some drawings or words are printed on the diffuser. Inside the frame is an illuminating device. The illuminating device emits light through the diffuser to produce an advertising effect.

The conventional advertising light box uses fluorescent lamps as the illuminating device. Multiple fluorescent tubes are separately mounted in the fluorescent lamp. Each fluorescent tube is electrically connected to each other and a power wire that extends to outside the advertising light box with a switch.

LED technique is very popular nowadays. Fluorescent lamps waste more energy than LED illuminating devices and have shorter lifetime. When one of the fluorescent tubes is broken, the fluorescent lamp will show a darker area corresponding to the broken fluorescent tube, so the advertising effect of the advertising light box is impaired.

### SUMMARY OF THE INVENTION

Conventional fluorescent lamps have high power consumptions and short lifetime issues. When parts of fluorescent lamps are broken in an advertising light box, an advertising effect is impaired. This invention relates to a modular LED illuminating device with low power consumption, long lifetime and multiple small area light sources. When one of the LED units is broken, the advertising effect is not affected obviously.

To accomplish the objective of this invention, this invention relates to a modular LED illuminating device that includes a case, multiple LED units and a power wire. The case includes a front cover and a rear cover; each cover has a first surface and a second surface, and the two covers can be joined each other. Multiple holding holes are formed through the front cover. A wire groove is formed on the rear cover.

The multiple LED units are respectively held by the multiple holding holes inside the case and electrically connected together.

The power wire is electrically connected to the multiple LED units, and the power wire is partially mounted in the wire groove.

Multiple upright posts are mounted on the first surface of the front cover, and each upright post has an end surface and a mounting hole formed through the end surface, wherein the end surfaces of the multiple upright posts abut against the first surface of the rear cover. Multiple concaves respectively correspond to the multiple upright posts and are formed on the second surface of the front cover.

Multiple mounting holes are formed through the rear cover, and respectively correspond to the mounting holes of the end surface of the upright posts of the front cover. Seal rings are respectively mounted around the multiple holding holes of the front cover.

Multiple holes are formed through the rear cover and communicate with the wire groove.

Multiple clamping plates are mounted adjacent to the wire groove of the second surface of the rear cover.

A positioning groove is formed in the wire groove; the power wire has a positioning plastic block mounted in the positioning groove.

At least one stub is mounted on the first surface of the front cover; at least one connecting groove corresponding to the at least one stub is formed on the first surface of the rear cover to joint with the at least one corresponding stub.

Two positioning blocks are mounted on the first surface of the front cover nearby each of the multiple holding holes; each of the multiple LED units is mounted between the two positioning blocks.

Multiple resistant blocks are mounted on the first surface of the rear cover; a top surface of each LED unit is abutted against the two positioning blocks, and a bottom surface of each LED unit is abutted against the multiple resistant blocks.

There are six LED units and six holding holes; three of the holding holes are formed through an upper side of the front cover, and the other three holding holes are formed through a lower side of the front cover.

By the description above, compared with a conventional fluorescent lamp, the modular LED illuminating device has long lifetime and saves more energy.

When this invention is installed inside an advertising light box, the multiple LED units are separately mounted and offer a small area light source. If one of the multiple LED units is broken, a light surface of the advertising light box just shows a small darker area corresponding to the broken LED unit. In contrast, when one of the conventional fluorescent tubes of an advertising light box is broken, the light surface of the advertising light box shows a rectangular darker area. As for the present invention, even though part of the LED units in the advertising light box are broken, the small darker areas are unobvious, so the modular LED illuminating devices, even if they are not promptly fixed, do not impair an advertising effect of the advertising light box.

On the other hand, using the seal ring can avoid moisture permeating into the case via the holding holes, so the modular LED illuminating device is waterproof to extend its lifetime. When multiple modular LED illuminating devices are connected together, the power wire can extend through the holes of the rear covers of the multiple modular LED illuminating devices and be fixed in the wire grooves by the multiple clamping plates and the positioning plastic block.

### BRIEF DESCRIPTION OF THE DRAWINGS

FIG. 1 is a perspective view of this invention;

FIG. 2 is an exploded perspective view of this invention;

FIG. 3 is a back plan view of this invention;

FIG. 4 is a cross sectional view of this invention; and

FIG. 5 is an operational view of this invention.

### DETAILED DESCRIPTION OF PREFERRED EMBODIMENT

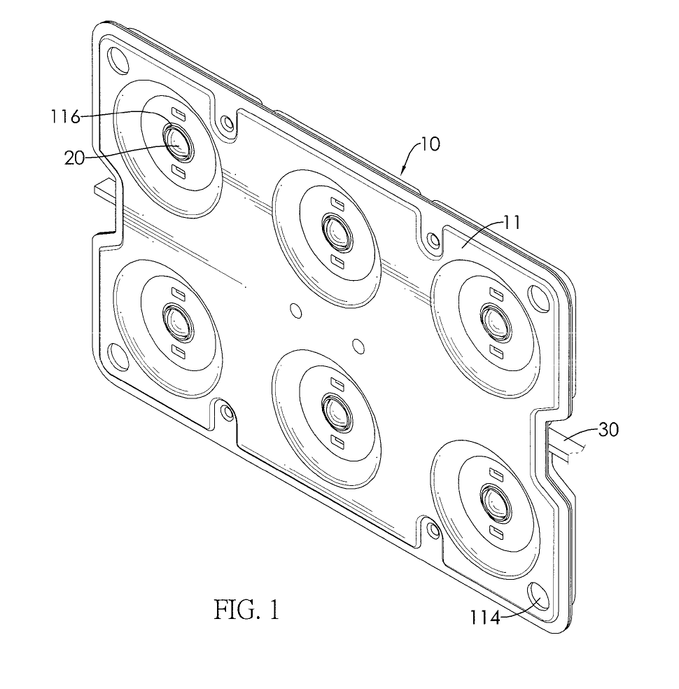

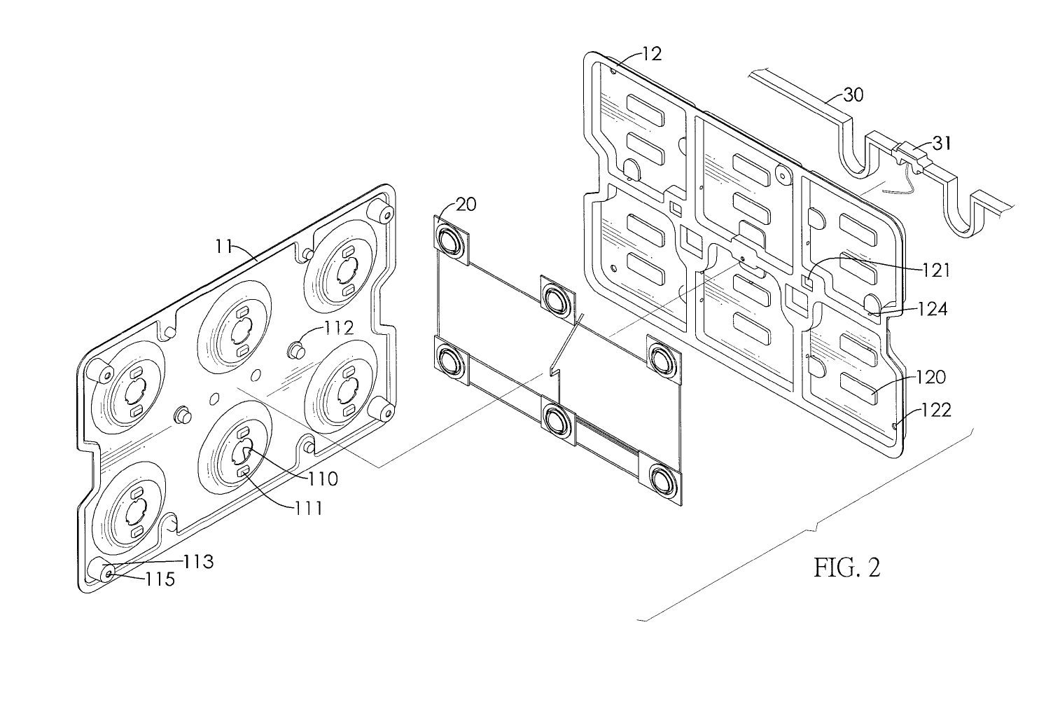

With reference to FIGS. 1 and 2, a modular LED illuminating device of the present invention includes a case 10, multiple LED units 20 and a power wire 30.

The case 10 includes a front cover 11 and a rear cover 12; each cover has a first surface and a second surface. The front cover 11 has a substantially rectangular shape. Multiple holding holes 110 are formed through the front cover 11. The first surface of the front cover 11 has multiple positioning blocks 111, two stubs 112 and four upright posts 113. The positioning blocks 111 are respectively mounted on two opposite sides nearby the multiple holding holes 110. The two stubs 112 are for separating the front cover 11 and the rear cover 12. The four upright posts 113 are respectively mounted at four corners of the first surface of the front cover 11. Four concaves 114 corresponding to the four upright posts 113 are formed on the second surface of the front cover 11. A mounting hole 115 is formed through an end surface of each upright post 113.

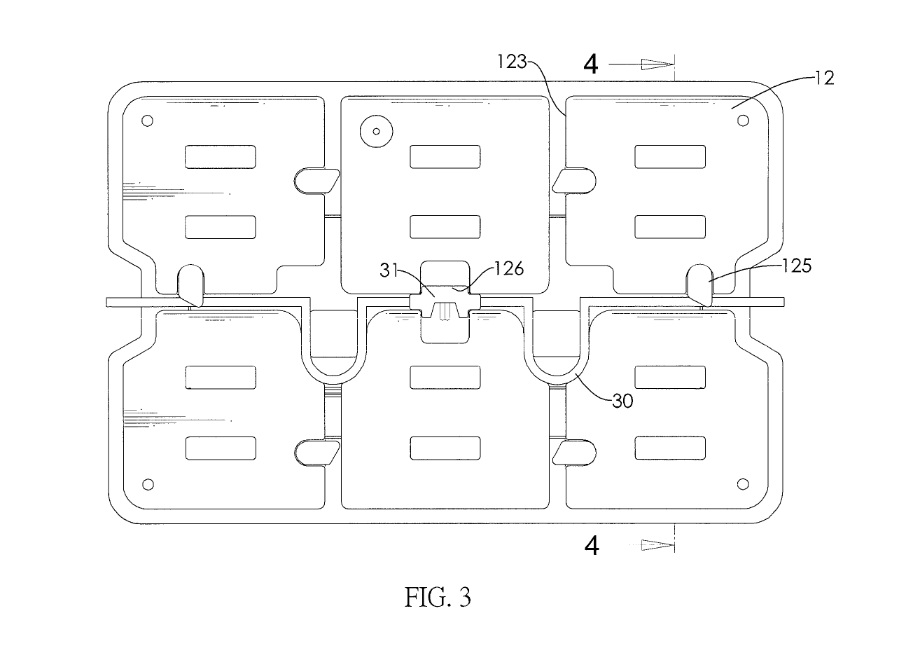

The rear cover 12 also has a substantially rectangular shape. The first surface of the rear cover 12 includes multiple resistant blocks 120, two connecting grooves 121 and four mounting holes 122. The resistant blocks 120 respectively correspond to the positioning blocks 111 and are mounted on the first surface of the rear cover 12. The two connecting grooves 121 correspond to the two stubs 112 and are formed on the first surface of the rear cover 12. The four mounting holes 122 are formed through the rear cover 12 and respectively correspond to the mounting holes 115 of the upright posts 113. With reference to FIG. 3, the second surface of the rear cover 12 is punched to form a wire groove 123. Multiple holes 124 are formed at a side of the wire groove 123.

The stubs 112 of the front cover 11 and the connecting grooves 121 of the rear cover 12 are respectively jointed each other. The positioning blocks 111 abut against the resistant blocks 120 respectively. The upright posts 113 are abutted against the first surface of the rear cover 12, so the mounting holes 115 of the upright posts 113 and the mounting holes 122 of the rear cover 12 communicate with each other. The front cover 11 and the rear cover 12 are mounted together by joining their edges through a high-frequency welding technique. The edges of both the front cover 11 and the rear cover 12 can also be fixed by glue or by connecting components.

In this embodiment, the front cover 11 has six holding holes 110. Three of the holding holes 110 are formed through an upper side of the front cover 11; the other three holding holes 110 are formed through a lower side of the front cover 11. Seal rings 116 are respectively mounted around the holding holes 110 of the front cover 11. Multiple clamping plates 125 are mounted adjacent to the wire groove 123 of the second surface of the rear cover 12. A positioning groove 126 crossing the wire groove 123 is formed in the center of the second surface of the rear cover 12.

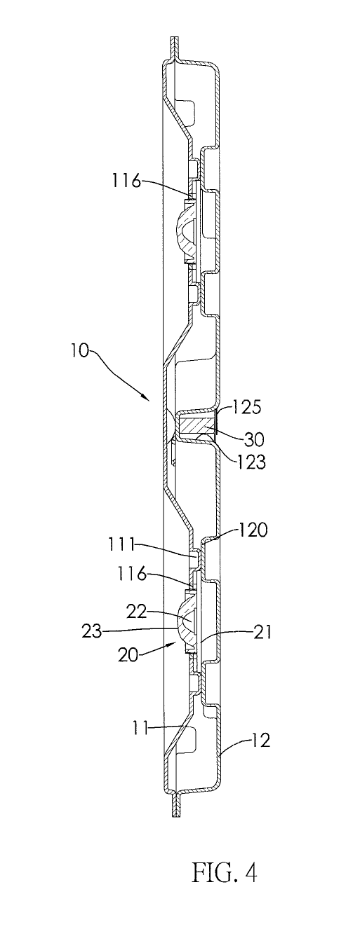

With reference to FIG. 4, each of the multiple LED units 20 comprises a circuit board 21, a light emitting diode 22 and a lampshade 23. The light emitting diode 22 is mounted on the circuit board 21. The lampshade 23 is a hollow shell in an arc shape; the light emitting diode 22 is covered with a concave surface of the lampshade 23, and the lampshade 23 is fixed on the circuit board 21. The multiple LED units 20 are electrically connected together and respectively held by the holding holes 110 inside the case 10. The lampshades 23 are also respectively held by the holding holes 110. The circuit board 21 is mounted between two of the positioning blocks 111. The circuit board 21 has a surface that is opposite to the light emitting diode 22, and the surface is abutted against the resistant blocks 120 of the first surface of the rear cover 12. In this embodiment, the six LED units 20 are respectively held by the six holding holes 110, and the seal rings 116 are respectively mounted around the lampshades 23. The power wire 30 and the multiple LED units 20 are connected together. The power wire 30 is partially mounted in the wire groove 123 of the rear cover 12, and the other part of the power wire 30 extends to outside the case 10 through the holes 124 of the rear cover 12. The power wire 30 has a positioning plastic block 31 mounted in the positioning groove 126.

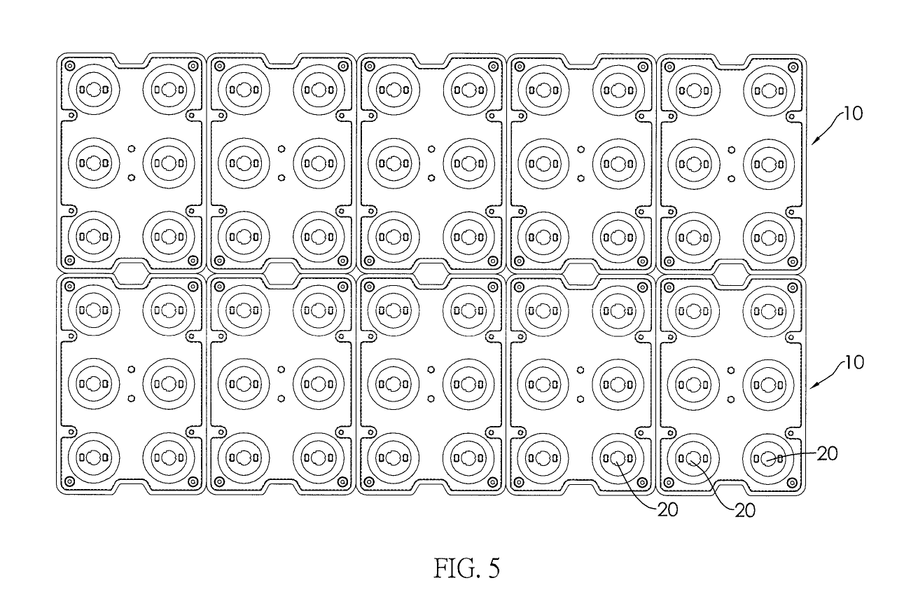

When the modular LED illuminating device is installed in an advertising light box, the case 10 can be fixed inside the advertising light box by mounting elements through the mounting holes 115 and 122. With reference to FIG. 5, the power wire 30 can be connected to multiple modular LED illuminating devices. By the above techniques applied to the LED illuminating device, and compared with a conventional fluorescent lamp, the multiple LED units 20 have long lifetime and save more energy. Using the seal rings 116 can avoid moisture permeating into the case 10 by the holding holes 110, so the modular LED illuminating device is waterproof to extend its lifetime.

With reference to FIG. 3, when multiple modular LED illuminating devices are connected together, the power wire 30 can extend through the holes 124 of the rear covers 12 of the multiple modular LED illuminating devices, and be fixed in the wire grooves 123 by the multiple clamping plates 125 and the positioning plastic block 31. With reference to FIG. 5, the multiple modular LED illuminating devices can be connected together in series or in parallel to be installed in an advertising light box for offering a large lighting area.

What is claimed is:

1. A modular LED illuminating device comprising:
a case comprising:
a front cover comprising:
a first surface; and
a second surface opposite to the first surface;
multiple holding holes formed through the front cover; and
a rear cover joined to the first cover and comprising:
a first surface;
a second surface opposite to the first surface; and
a wire groove formed on the second surface;
multiple LED units respectively held by the multiple holding holes inside the case and electrically connected together; and
a power wire electrically connected to the multiple LED units and partially mounted in the wire groove.

2. The modular LED illuminating device as claimed in claim 1, wherein
multiple upright posts are mounted on the first surface of the front cover, and each upright post has an end surface and a mounting hole formed through the end surface, wherein the end surfaces of the multiple upright posts abut against the first surface of the rear cover;
multiple concaves respectively correspond to the multiple upright posts and are formed on the second surface of the front cover; and
multiple mounting holes are formed through the rear cover and respectively correspond to the mounting holes of the end surface of the upright posts of the front cover.

3. The modular LED illuminating device as claimed in claim 2, wherein the seal rings are respectively mounted around the multiple holding holes of the front cover.

4. The modular LED illuminating device as claimed in claim 1, wherein multiple holes are formed through the rear cover and communicate with the wire groove.

5. The modular LED illuminating device as claimed in claim 2, wherein multiple holes are formed through the rear cover and communicate with the wire groove.

6. The modular LED illuminating device as claimed in claim 3, wherein multiple holes are formed through the rear cover and communicate with the wire groove.

7. The modular LED illuminating device as claimed in claim 4, wherein multiple clamping plates are mounted adjacent to the wire groove of the second surface of the rear cover.

8. The modular LED illuminating device as claimed in claim 5, wherein multiple clamping plates are mounted adjacent to the wire groove of the second surface of the rear cover.

9. The modular LED illuminating device as claimed in claim 6, wherein multiple clamping plates are mounted adjacent to the wire groove of the second surface of the rear cover.

10. The modular LED illuminating device as claimed in claim 7, wherein a positioning groove is formed in the wire groove; and the power wire has a positioning plastic block mounted in the positioning groove.

11. The modular LED illuminating device as claimed in claim 8, wherein a positioning groove is formed in the wire groove; and the power wire has a positioning plastic block mounted in the positioning groove.

12. The modular LED illuminating device as claimed in claim 9, wherein a positioning groove is formed in the wire groove; and the power wire has a positioning plastic block mounted in the positioning groove.

13. The modular LED illuminating device as claimed in claim 10, wherein at least one stub is mounted on the first surface of the front cover; at least one connecting groove corresponding to the at least one stub is formed on the first surface of the rear cover to joint with the at least one corresponding stub.

14. The modular LED illuminating device as claimed in claim 11, wherein at least one stub is mounted on the first surface of the front cover; at least one connecting groove corresponding to the at least one stub is formed on the first surface of the rear cover to joint with the at least one corresponding stub.

15. The modular LED illuminating device as claimed in claim 12, wherein at least one stub is mounted on the first surface of the front cover; at least one connecting groove corresponding to the at least one stub is formed on the first surface of the rear cover to joint with the at least one corresponding stub.

16. The modular LED illuminating device as claimed in claim 13, wherein
two positioning blocks are mounted on the first surface of the front cover nearby each of the multiple holding holes; each of the multiple LED units is mounted between the two positioning blocks;
multiple resistant blocks are mounted on the first surface of the rear cover; and
a top surface of each LED unit is abutted against the two positioning blocks and a bottom surface of each LED unit is abutted against the multiple resistant blocks.

17. The modular LED illuminating device as claimed in claim 14, wherein
two positioning blocks are mounted on the first surface of the front cover nearby each of the multiple holding holes; each of the multiple LED units is mounted between the two positioning blocks; and
multiple resistant blocks are mounted on the first surface of the rear cover; a top surface of each LED unit is abutted against the two positioning blocks and a bottom surface of each LED unit is abutted against the multiple resistant blocks.

18. The modular LED illuminating device as claimed in claim 15, wherein
two positioning blocks are mounted on the first surface of the front cover nearby each of the multiple holding holes; each of the multiple LED units is mounted between the two positioning blocks; and
multiple resistant blocks are mounted on the first surface of the rear cover; a top surface of each LED unit is abutted against the two positioning blocks and a bottom surface of each LED unit is abutted against the multiple resistant blocks.

19. The modular LED illuminating device as claimed in claim 16, wherein there are six LED units and six holding holes; three of the holding holes are formed through an upper side of the front cover, and the other three holding holes are formed through a lower side of the front cover.

20. The modular LED illuminating device as claimed in claim 17, wherein there are six LED units and six holding holes; three of the holding holes are formed through an upper side of the front cover, and the other three holding holes are formed through a lower side of the front cover.
